(19) United States
(12) Patent Application Publication
(10) Pub. No.: US 2013/0139420 A1
(43) Pub. Date: Jun. 6, 2013

(54) POP-UP FORMAT

(71) Applicant: Sharon Rubar, Crest Hill, IL (US)

(72) Inventor: Sharon Rubar, Crest Hill, IL (US)

(73) Assignee: THE LEHIGH PRESS LLC, Broadview, IL (US)

(21) Appl. No.: 13/311,931

(22) Filed: Dec. 6, 2011

(51) Int. Cl. G09F 1/06; B31B 1/26; B31B 1/62; B31B 1/88; B31B 1/14

(52) U.S. Cl. 40/124.08; 493/54; 493/56; 493/128; 493/162; 493/343

(57) ABSTRACT

A pop-up format is described, the format comprising a substrate and a box, the substrate comprising a flat sheet having a first part and a second part separated by a substrate fold line, the first part having a top side and a bottom side, the second part having a top side and a bottom side, and the box comprising an upper section and a lower section, the upper section comprising a display portion and a first fastening portion and the lower section comprising a second fastening portion, a raising portion, and a connection portion, the connection portion adhering to the display portion, the first fastening portion adhering to the second part top side and the second fastening portion adhering to the first part top side, the display portion having an area less than an area of the second part of the substrate. A method of manufacture is described as well.

### BACKGROUND OF THE INVENTION

This invention is generally directed to an in-line finishing system for manufacturing an advertising format with a pop-up assembly in a single-pass manufacturing process, using no premanufactured portions. The invention is more specifically directed to an in-line finishing system for manufacturing an advertising format with a pop-up assembly, the pop-up assembly being smaller than the advertising format, to incorporate in a mass-distributable packet, in a single-pass manufacturing process, using no pre-manufactured portions.

Advertisers commonly use mass-distributable packets to promote their products. These packets are distributed by mail, by insert into newspapers or other periodicals, by hand delivery, or otherwise. Advertisers often wish to incorporate a pop-up assembly into a mass-distributable packet. A pop-up assembly will catch the reader's attention and hold that attention for a longer span than the same advertising content without a pop-up assembly, Advertisers desire a pop-up assembly that is smaller than the substrate and appears to raise the advertising content in the same plane as the substrate, without the need for a spring.

Some pop-up formats have a box having a length the same as the length of the substrate (a “full-length box pop-up”). Some advertisers, however, do not want the box to have the same length as the substrate. Having a box smaller than the substrate gives the appearance of a card popping up from the substrate. Moreover, having a smaller box allows for the possibility of multiple boxes on the substrate, not all of which need to be of the same size as each other.

Additionally, advertisers often wish to include a removable portion in the advertising materials. A removable portion is described in U.S. Pat. Nos. 7,017,899, 7,434,795, 7,469,887, 7,540,481, 7,618,032, and 7,658,371, the disclosures of all of which are incorporated herein. A removable portion, also referred to herein as an advertising format card, may attract the reader's attention more readily if it is presented by means of a pop-up assembly, rather than merely glued to the mass-distributable packet. An advertising format card on a box that is smaller than the substrate and smaller than the advertising format card is desired by some advertisers, and is even more desirable if the card appears to rise from the plane of the substrate.

There is a need for a less expensive, easily set up, single-pass system to provide a pop-up assembly in an advertising format that is smaller than the substrate and appears to rise from the plane of the substrate, to provide a pop-up assembly in an advertising format incorporated into a mass-distributable packet, and to provide an advertising card presented by means of a pop-up assembly, either in an advertising format or in an advertising format incorporated into a mass-distributable packet, that has the appearance of a card popping up from the plane of the substrate.

### BRIEF SUMMARY OF THE INVENTION

Briefly, and in accordance with the foregoing, the pop-up format of the present invention comprises a substrate and a box, the substrate comprising a flat sheet having a first part and a second part separated by a substrate fold line, the first part having a top side and a bottom side, the second part having a top side and a bottom side, and the box comprising an upper section and a lower section, the upper section comprising a display portion and a first fastening portion and the lower section comprising a second fastening portion, a raising portion, and a connection portion, the connection portion adhering to the display portion, the first fastening portion adhering to the second part top side and the second &stetting portion adhering to the first part top side, the display portion having an area less than an area of the second part of the substrate. A method of manufacture is described as well.

### BRIEF DESCRIPTION OF THE SEVERAL VIEWS OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a perspective view of the pop-up format of the preferred embodiment of the present invention, in Which the substrate is partially opened.

FIG. 2 is an elevation view of the pop-up format of FIG. 1, in which the substrate is partially open.

FIG. 3A is an elevation view of the pop-up format of FIG. 1 during manufacture.

FIG. 3B is an elevation view of another embodiment of the pop-up format of FIG. 1 during manufacture.

FIG. 4 is an elevation view of another embodiment of the present invention.

FIG. 5 is a schematic view of the process of manufacture of the preferred embodiment of the invention.

FIG. 6A is a top perspective view of the top ribbon of the preferred embodiment of the present invention during manufacture.

FIG. 6B is a top view of the top ribbon of FIG. 6A at another point during manufacture FIG. 6C is a bottom view of the top ribbon of FIG. 6B.

FIG. 6D is an elevation view of the preferred embodiment of the top ribbon of FIG. 6B.

FIG. 7 is an elevation view of another embodiment of the top ribbon of FIG. 6B.

FIG. 8 is a bottom view of the top ribbon of another embodiment of the present invention during manufacture.

FIG. 9 is a perspective view of the pop-up format of the embodiment of FIG. 8, in which the substrate is partially open.

### DETAILED DESCRIPTION OF THE PREFERRED EMBODIMENTS OF THE INVENTION

While the invention may be susceptible to embodiments in different forms, there is shown in the drawings, and herein will be described in detail, specific embodiments with the understanding that the present disclosure is to be considered an exemplification of the principles of the invention, and is not intended to limit the invention to that as illustrated and described herein.

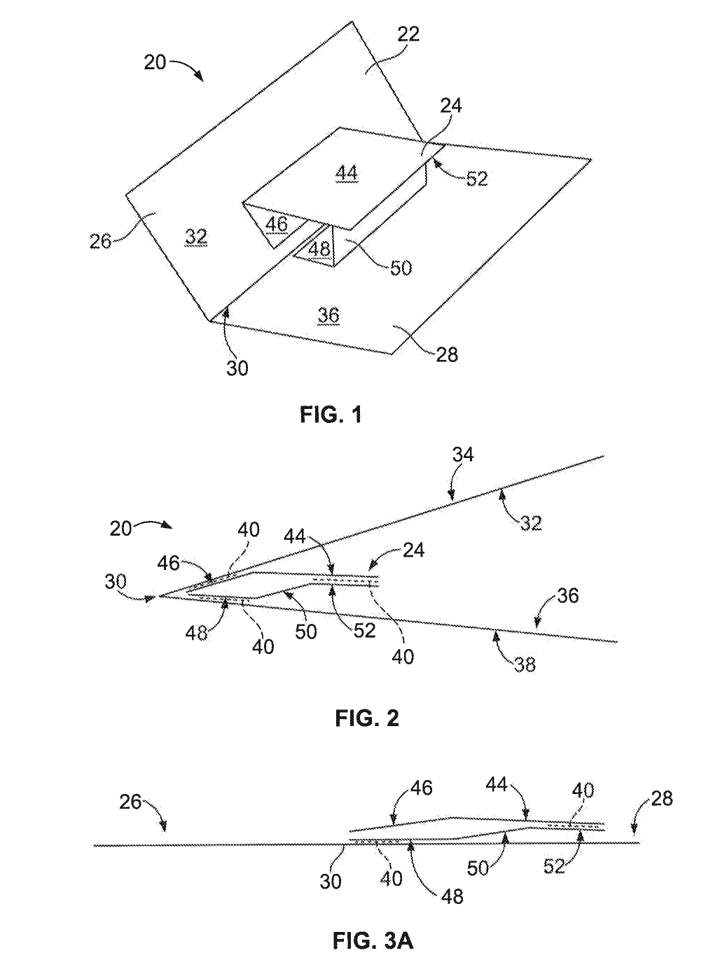

In a first embodiment, pop-up format 20 comprises a substrate 22 and a box 24 as shown in schematic form in FIGS. 1, 2, and 3. Substrate 22 is generally a flat sheet known as a “four-page” carrier, as it has a first part 26 and a second part 28, separated by fold line 30. First part 26 has a first page 32 and a second page 34 opposite page 32. Second part 28 has a third page 36 and a fourth page 38 opposite page 36. Box 24 adheres to substrate 22 by adhesive 40, applied in various locations, as will hereinafter be described. Adhesive 40 is preferably a solvent-based emulsion adhesive, most preferably a hot-melt adhesive, or alternatively a water-based emulsion adhesive, or some other adhesive.

Box 24 as shown in FIGS. 1 through 3A comprises five portions, a display portion 44, a first fastening portion 46, a second fastening portion 48, a raising portion 50, and a connection portion 52. When pop-up format 20 is fully assembled, first fastening portion 46 adheres by adhesive 40 to first page 32 of first part 26, second fastening portion 48 adheres by adhesive 40 to third page 36 of second part 28, and connection portion 52 adheres by adhesive 40 to display portion 44. In the preferred embodiment, as shown in FIGS. 1 through 3A, connection portion 52 extends distally from fold line 30. Connection portion 52 can extend proximally toward fold line 30, however.

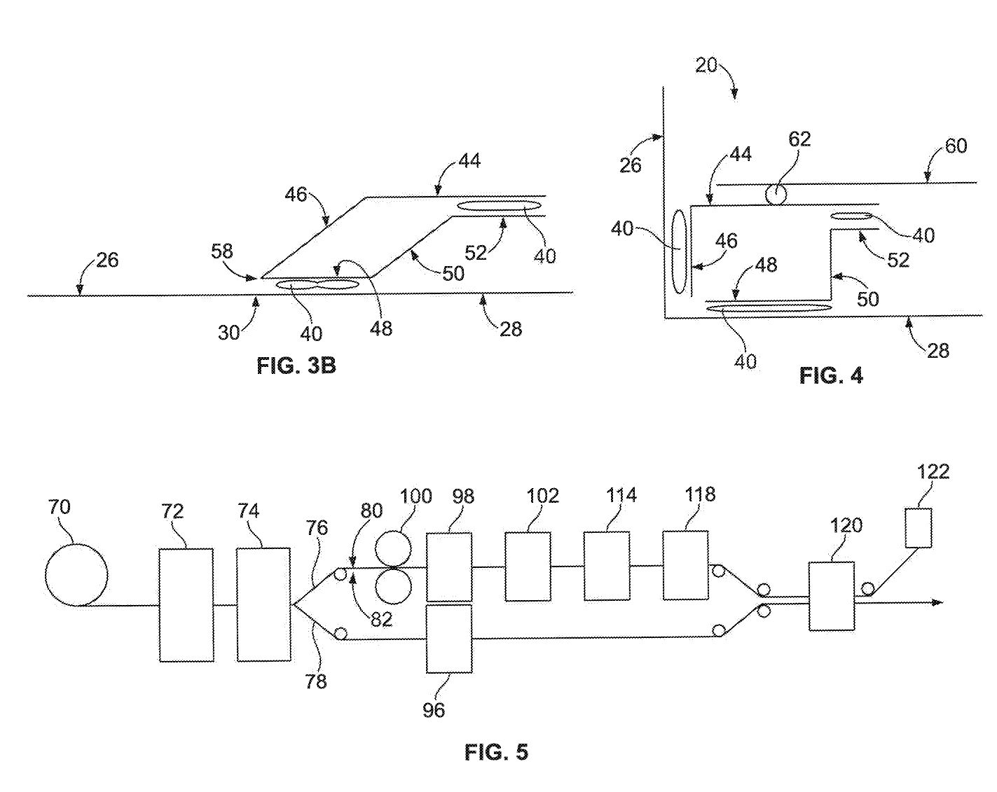

Preferably, box 24 when assembled is two separate pieces, an upper section 54, consisting of portions 44 and 46, and a lower section 56, consisting of portions 48, 50, and 52. Alternatively, box 24 could be made of a single piece, so that display portion 44 and connection portion 52 are joined at a fold line 58, as shown in FIG. 3B.

Display portion 44 in the preferred embodiment is a right quadrilateral parallelogram, preferably a right rectangle. Display portion 44 in this embodiment has a width in the dimension parallel to fold line 30 and a length in the perpendicular dimension. in this embodiment, the width of display portion 44 is the same as the width of raising portion 50. At least one of the width of display portion 44 and the length of display portion 44 is less than the corresponding width and length of third page 36. Preferably, both the length and width of display portion 44 are less than the corresponding width and length of third page 36, but in any event the area of display portion 44 is less than the area of third page 36.

In another embodiment, an advertising format card 60 is adhered to display portion 44, as shown in FIG. 4. Card 60 is preferably adhered to display portion 44 by spot glue 62, so that a recipient of pop-up format 20 can easily remove card 60 from pop-up assembly 24. Card 60 can also be adhered to display portion 44 by adhesive 40, so that card 60 is not easily removable. Card 60 can also be adhered to display portion 44 by any other suitable means of adhering, such as staples.

Card 60 is preferably structure as described in any of U.S. Pat. Nos. 7,017,899, 7,434,795, 7,469,887, 7,540,481, 7,618,032, and 7,658,371, the disclosure of each of which is incorporated herein by reference, and is preferably manufactured as described in any of those patents. Preferably, the area of card 60 is greater than the area of display portion 44 and less than the area of third page 36.

A method of manufacture of pop-up format 20 will now be described. A first method produces pop-up format 20 without card 60. A second method will be described to produce pop-up format with card 60.

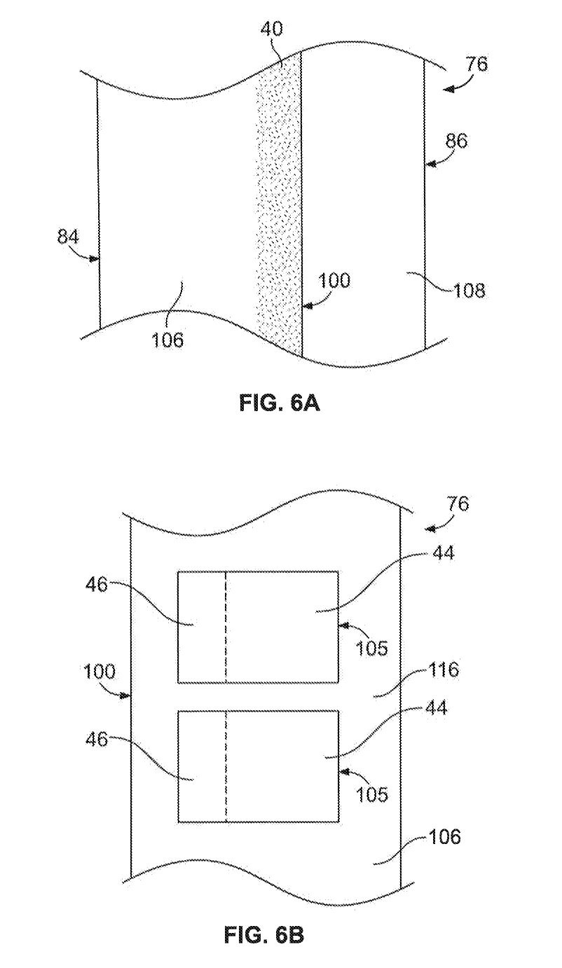

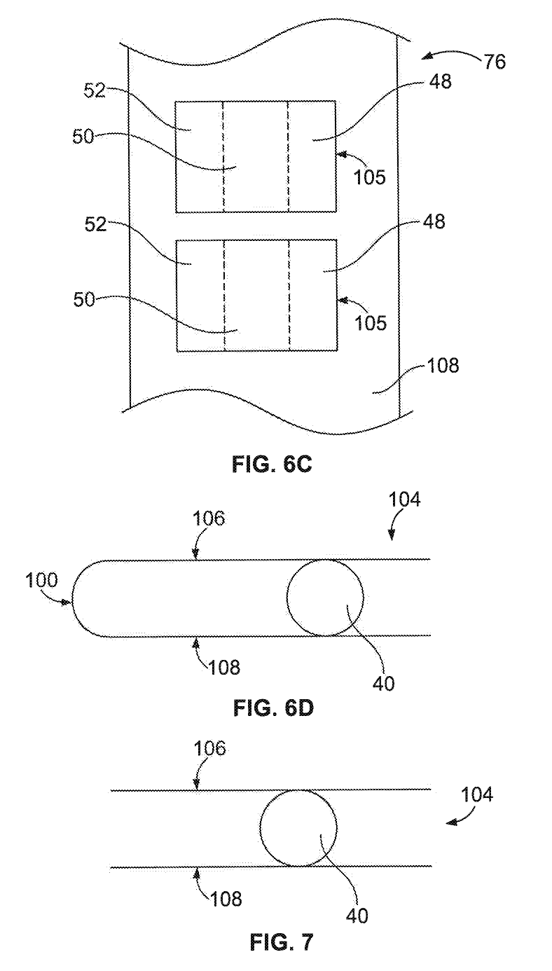

In the first method, a web 70 of paper is printed on a web press 72, as shown in diagrammatic form in FIG. 5. After the web 70 is printed, it is slit, folded, glued, and subjected to various finishing operations to form pop-up format 20. First, slitter 74 slits web 70 into two ribbons, upper ribbon 76 and lower ribbon 78. Upper ribbon 76 has a top side 80, a bottom side 82, a first edge 84, and a second edge 86. Lower ribbon 78 has a top side 88, a bottom side 90, a first edge 92, and a second edge 94. Lower ribbon 78 has fold line 30 formed therein, preferably midway between first edge 92 and second edge 94, at perforation wheel station 96, as shown in FIG. 6. Lower ribbon 78 will become substrate 22 of pop-up format 20.

Upper ribbon 76, in the preferred embodiment, as shown in FIG. 6A, has adhesive 40 applied to what will become connection portion 52, at glue station 98, as shown in FIG. 5, Adhesive 40 can alternatively be applied to part of what will become display portion 44. Next, upper ribbon 76 is folded onto itself at fold line 100 by plow station 102 to form a two-ply ribbon 104, as shown in FIGS. 6B through 6D. First ply 106 therefore adheres to second ply 108, but not throughout the entirety of two-ply ribbon 104, but rather only partially, at what will become connection portion 52 and part of display portion 44.

In an alternative method, upper ribbon 76 is slit into two ribbons, first ribbon 106 and second ribbon 108. Adhesive 40 is applied to a portion of at least one of first ribbon 106 and second ribbon 108 and the two ribbons are married to form two-ply ribbon 104, with first ply 106 partially adhering to second ply 108, as shown in FIG. 7.

First die cutter 114, preferably a rotary die cutter, then applies die cut 105 into two-ply ribbon 104 to form upper section 54 and lower section 56, leaving matrix 116, as shown in FIGS. 6B and 6C. Upper section 54 is formed by one die of first die cutter 114 in first ply 106 of two-ply ribbon 104 and lower section 56 is formed by the second die of first die cutter 114 in second ply 108 of two-ply ribbon 104. Because adhesive 40 was applied previously, display portion 44, which is in upper section 54, is adhered to connection portion 52.

In the meantime, adhesive 40 is applied at glue station 118 to lower ribbon 78, which will become substrate 22, in two places, at first part adhering portion 120 on first page 32 and at second part adhering portion 122 on third page 36. Substrate fold line 30 is formed in substrate 22 at perforation wheel station 124. Two-ply ribbon 104 is then married to lower ribbon 78, preferably so that second fastening portion 48 adheres to second part adhering portion 122. Alternatively, two-ply ribbon 104 could be married to lower ribbon 78 so that first fastening portion 46 adheres to first part adhering portion 120. Matrix 116 is then pulled away at matrix removal station 126, leaving box 24 adhered to lower ribbon 78.

Lower ribbon 78 is then folded at fold line 30 by plow station 128. This folding step causes the other of the two fastening portions 46, 48 to adhere to the other of the two adhering portions 120, 122, so that box 24 is now adhered to lower ribbon 78 in two places. Final rotary die cutter 130 then transversely cuts lower ribbon 78 to form multiple pop-up formats 20.

Finishing operations can be applied to upper ribbon 76 or lower ribbon 78 at any point in the process. For example, a coating, such as a UV underlayment, may be applied to either of upper ribbon 76 or lower ribbon 78. Other coatings can be used as is known in the art, and other finishing operations can be used as is known in the art, including by way of examples and not by way of limitations, further folding, aqueous coating, overall and spot UV coatings, film lamination, embossing, foil and hologram stamping, and post embossing, if desired.

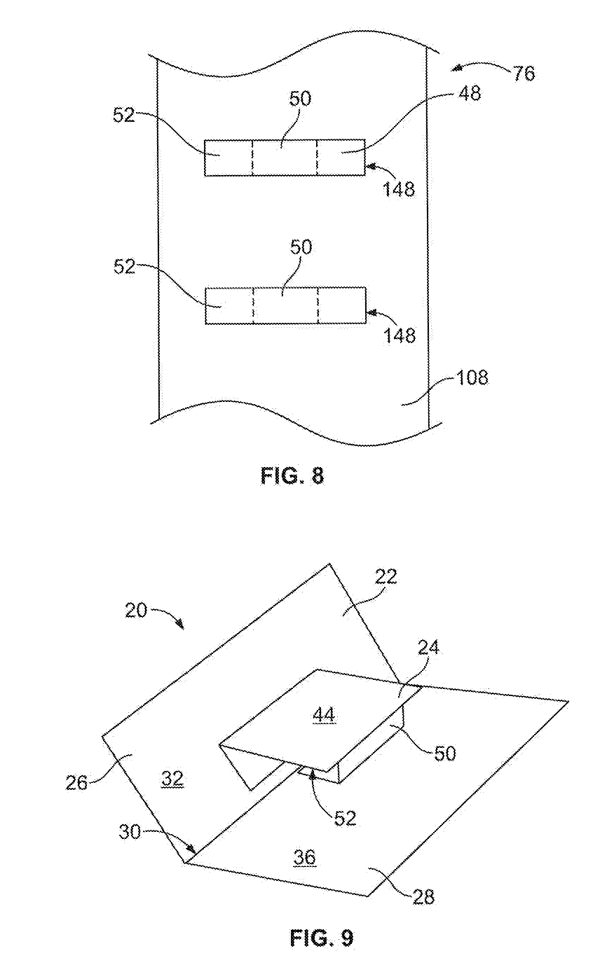

In another refinement to this method, two different-sized die cuts can be used. In this alternative, first die cutter 114 has a high-load die. Upper section 54, comprising display portion 44 and first fastening portion 46, is formed by one die of first die cutter 114 in first ply 106 of two-ply ribbon 104, as shown in in FIG. 6B. However, the second die of first die cutter 114 is smaller and forms lower section 56, comprising second fastening portion 48, raising portion 50, and connection portion 52 as shown in FIG. 8. Please note that the same effect can be achieved by use of two separate die cutters instead of a single first die cutter 114 with a high-load die.

By this alternative method, lower section 56 and upper section 54 can have different dimensions, For example, in FIG. 9, upper section 54 is wider and longer than lower section 56, so that display portion 44 is both wider and longer than raising portion 50. The dimensions of the die cuts can be changed if desired so that upper section 54 is wider but not longer, or longer but not wider, than lower section 56.

Please note that none of portions 44 through 52 need be rectangular, as shown in the drawings. The die cutter or die cutters can use any variety of blades to form portions 44 through 52 in any type of shape. If other shapes are used, first die cutter 114 should be configured so that the area of display portion 44 is less than the area of third page 36.

The method of manufacturing the preferred embodiment of pop up format 20, using the slit and marry alternative, comprises the following steps, which need not necessarily be performed in this order:

201 Print a web 70

203 Slit the web into at least two ribbons, an upper ribbon 76 and a lower ribbon 78.

205 Form substrate fold line 30 in lower ribbon 78.

207 Apply adhesive 40 to selected portions 120, 122 of lower ribbon 78.

209 Slit upper ribbon 76 into a first ribbon 110 and a second ribbon 112.

211 Apply adhesive 40 to a portion of at least one of first ribbon 110 and second ribbon 112.

213 Marry first ribbon 110 to second ribbon 112 to form two-ply ribbon 104.

215 Die cut two-ply ribbon 104 to form upper section 54 and lower section 56.

217 Marry two-ply ribbon 104 to lower ribbon 78.

219 Remove matrix 116.

271 Fold lower ribbon 78 at substrate fold line 30.

223 Transversely cut lower ribbon 78 to form pop-up formats 20.

The method of manufacturing the preferred embodiment of pop up format 20, using the fold and glue alternative, comprises the following steps, which need not necessarily be performed in this order:

301 Print a web 70.

303 Slit the web 70 into at least two ribbons, an upper ribbon 76 and a lower ribbon 78.

305 Form substrate fold line 30 in lower ribbon 78.

307 Apply adhesive 40 to selected portions 120, 122 of lower ribbon 78.

309 Apply adhesive 40 to a portion of upper ribbon 76.

311 Fold upper ribbon 76 upon itself to form two-ply ribbon 104.

313 Die cut two-ply ribbon 104 to form upper section 54 and lower section 56.

315 Marry two-ply ribbon 104 to lower ribbon 78.

317 Remove matrix 116.

319 Fold lower ribbon 78 at substrate fold line 30.

321 Transversely cut lower ribbon 78 to form pop-up formats 20.

In another aspect of the present invention, web 70 is slit into three ribbons. The first two ribbons are lower ribbon 76 and upper ribbon 78, which are processed as discussed above. The third ribbon 150 is manufactured into an advertising format card 60 by one of the methods described in U.S. Pat. No. Nos. 7,017,899, 7,434,795, 7,469,887, 7,540,481, 7,618,032, and 7,658,371. Before lower ribbon 76 is folded at substrate fold line 30, third ribbon 150 is married to lower ribbon 76 so the card 60 is in registry with display portion 44. Preferably, spot glue 152 is used to adhere card 60 to display portion 44, so that card 60 is easily removable from pop-up assembly 24. Alternatively, adhesive 40 can be used to adhere card 60 to display portion 44, making it more difficult to remove card 60. Other means to adhere card 60 to display portion 44 can be used, such as one or more staples, pressure-activated adhesive, or other means. After card 60 is adhered to display portion 44, the matrix 154 of third ribbon 150 is removed, as described in the above-referenced United States patents.

In yet other embodiments, web 70 is slit into multiple ribbons. Two ribbons are used to manufacture pop-up format 20 as described above. The remaining ribbon or ribbons can be folded and glued as needed to form, for example, one or more additional boxes 24, which are attached to lower ribbon 78 as described above so that final pop-up format 20 has a plurality of boxes 24 that pop up when substrate 22 is opened.

Additionally, other ribbons can be used to form other components of a mass-distributable packet. For example, one ribbon can be formed into a return envelope for the recipient to send back to order goods or services or otherwise reply to the information in the packet.

Please note that the embodiments described above use a four-page substrate. The same method can be used to form pop-up formats 20 on other types of substrates. For example, a single box 24 can be formed on one side of a six-page substrate 22, or two boxes 24 could be formed, one on each side of a six-page substrate 22, or other multiple-page, multiple boxes can be formed.

While preferred embodiments of the present invention are shown and described, it is envisioned that those skilled in the art may devise various modifications of the present invention.

1. A pop-up format comprising a substrate and a box,
the substrate comprising a fiat sheet having a first part and a second part separated by a substrate fold line, the first part having a top side and a bottom side, the second part having a top side and a bottom side; and
a box comprising an upper section and a lower section, the upper section comprising a display portion and a first fastening portion and the lower section comprising a second fastening portion, a raising portion, and a connection portion, the connection portion adhering to the display portion, the first fastening portion adhering to the second part top side and the second fastening portion adhering to the first part top side, the display portion having an area less than an area of the second part of the substrate.

2. The pop-up format of claim 1, wherein the connection portion adheres to the display portion by an adhesive, the first fastening portion adheres to the second part top side by an adhesive, and the second fastening portion adheres to the first part top side by an adhesive.

3. The pop-up format of claim 1, further comprising an advertising format card adhering to the display portion.

4. The pop-up format of claim 3, wherein the advertising format card adheres to the display portion by an adhesive.

5. The pop-up format of claim 3, wherein the advertising format card adheres to the display portion by spot glue.

6. The pop-up format of claim 1, wherein the display portion has an area less than the area of the second part.

7. The pop-up format of claim 1, wherein the display portion has a width greater than a width of at least one of the first fastening portion, the second fastening portion, and the raising portion.

8. The pop-up format of claim 1, further comprising a second box comprising a second box upper section and a second box lower section, the second box upper section comprising a second box display portion and a second box first fastening portion and the second box lower section comprising a second box second fastening portion, a second box raising portion, and a second box connection portion, the second box connection portion adhering to the second box display portion, the second box first fastening portion adhering to the second part top side and the second box second fastening portion adhering to the first part top side, the second box display portion having an area less than an area of the second part of the substrate.

9. A method of manufacturing a pop-up format, comprising the steps of:
printing a web;
slitting the web into a plurality of ribbons, the plurality of ribbons comprising an upper ribbon and a lower ribbon;
forming a substrate fold line in the lower ribbon;
applying a first adhesive to a side of the upper ribbon;
folding the upper ribbon upon itself to form a multi-ply ribbon comprising at least two ribbons;
die-cutting the multi-ply ribbon into a box and a matrix, the box comprising an upper section and a lower section, the upper section comprising a display portion and a first fastening portion and the lower section comprising a second fastening portion, a raising portion, and a connection portion;
applying a second adhesive to selected portions of the lower ribbon;
marrying the multi-ply ribbon to the lower ribbon so one of the first fastening portion and the second fastening portion adheres to a first one of the selected portions of the lower ribbon;
removing the matrix;
folding the lower ribbon upon itself so another one of the first fastening portion and the second fastening portion adheres to a second one of the selected portions of the lower ribbon; and
transversely cutting the lower ribbon.

10. The method of claim 9, wherein the plurality of ribbons further comprises a third ribbon and the method further comprises the steps of:
forming an advertising format card from the third ribbon; and
adhering the advertising format card to the display portion.

11. The method of claim 10, wherein the adhering the advertising format card step comprises using means for adhering the advertising format card to the display portion.

12. The method of claim 10, wherein the adhering the advertising format card step comprises using one of an adhesive and a spot glue.

13. The method of claim 9, wherein the die-cutting the multi-ply ribbon into a box and a matrix comprises a step of die-cutting a first ply of the multi-ply ribbon and a step of die-cutting a second play of the multi-ply ribbon.

14. The method of claim 9, wherein the die-cutting ribbon into a box and a matrix comprises using a die cutter with high-low blades.

15. The method of claim 9, wherein the die-cutting the multi-ply ribbon into a box and a matrix comprises cutting the display portion to have a width greater than the width of at least one of the first fastening portion, the second fastening portion, and the raising portion.
